(19) United States
(12) Patent Application Publication
(10) Pub. No.: US 2014/0090377 A1
(43) Pub. Date: Apr. 3, 2014

(54) Nuclear-Fossil Fueled Hybrid Power Generation System

(71) Applicant: Michael John DiMonte, Cranberry Township, PA (US)

(72) Inventor: Michael John DiMonte, Cranberry Township, PA (US)

(21) Appl. No.: 14/039,353

(22) Filed: Sep. 27, 2013

Related U.S. Application Data
(60) Provisional application No. 61/708,063, filed on Oct. 1, 2012.

(51) Int. Cl. G21D 1/00

(52) U.S. Cl. CPC G21D 1/00
USPC 60/644.1

(57) ABSTRACT

An electric generating system employing a nuclear reactor to heat feedwater prior to fossil fueled boiler and superheater sections to economically produce electricity with reduced greenhouse gas and other polluting emissions

### TECHNICAL FIELD

The invention is a power generating system as represented in USPTO Patent Classes: 60—Power Plants, 110—Furnaces, and 431—Combustion.

More specifically this is can be widely employed as a stationary electric power generation system commonly operated by electric utility companies and industrial companies requiring electric power to operate process lines.

### BACKGROUND

This invention relates to the economical generation of electric power from fossil fuels with reduced emissions of greenhouse gases, carbon dioxide, sulfur oxides, nitrous oxides, mercury, flue gas particulates, sludge, and other environmental pollutants. Existing electric power generating systems utilize fossil fuels, nuclear, hydroelectric, wind, solar, geothermal, and other energy sources. The dominant fuel source in the United States, China, and certain other industrialized countries is coal, which emits CO2 at a rate of approximately 900 grams per kWh (250 g/MJ). Newer gas fired combined cycle power plants emit approximately 460 gram of CO2 per kWh (128 g/MJ). Other energy sources can emit lower levels of pollutants per unit of electric energy but all are less plentiful, reliable, and typically more costly.

Global warming is recognized to be threat to society. Human activity, including stationary electric power generation, is now generally acknowledged in the scientific community to be a significant contributor to the accelerating rate of climate change.

Industrialized countries have a significant investment in existing operating fossil fueled power plants and associated electric distribution systems. Therefore there is economic inertia to continue operating these plants; however this exasperates initiatives to modernize and replace highly polluting plants with lower emission or non-polluting technologies. This invention represent a unique approach to reduce emissions in the near term by replacing a significant fraction of the existing polluting generating capacity with non-polluting nuclear energy that is economically practical.

Prior art to reduce greenhouse gas and other emissions through the combination of nuclear and fossil fuels are uneconomical and/or unreliable. The closest approximation to the current invention is the “Apparatus and method for producing electrical power”, U.S. Pat. No. 5,361,377, Nov. 1, 1994 which introduced the addition of a heat exchanger to superheat steam generated by a Pressurized Water Reactor, which is subsequently directed through a steam turbine and generator set. The referenced method is inferior to the current invention for two reasons. 1) The operating pressure of the turbine is reduced to the level achievable by and Pressurized Water Reactor, which is approximately 1,000 psig (6.9 MPa) versus the 2,500 psig (20.7 MPa) nominal operating pressure of a fossil fueled plant. Therefore the overall process efficiency is limited to approximately 33 percent versus 39 percent typically achieved in fossil fueled Rankine cycle plants. Still higher efficiencies are achievable when this invention is applied to higher pressure cycles. 2) The referenced method is not applicable to repowering existing fossil fueled power plants and therefore does not take economic advantage of the established infrastructure of the largest fraction of existing power plants.

Other more recent hybrid energy systems which incorporate nuclear energy, such as the Gen IV Hybrid—Nuclear/Natural Gas Synfuels system by the Idaho National Laboratory, May 2011 involve complex gas reforming, methanol synthesis and related processes that make the process economically unattractive.

### SUMMARY OF INVENTION

The present invention prescribes the optimized arrangement and integration of equipment and systems in an electric generating plant to enable reliable production of electric power with reduced emissions of greenhouse gases and other pollutants. More specifically it establishes the utilization of a nuclear reactor as the heat source for the feed water heating at high pressure prior to the evaporation and superheating of the working fluid by means of fossil fuels. When applied to existing fossil fueled (including coal) generating stations it results in a substantial improvement in the rate of emission per unit of energy generated. Additionally the introduction of the present invention as a method of power plant life extension improves the economics of electric power through use of installed infrastructure including the turbine-generator set, transformers, other balance of plant equipment and electric transmission equipment.

### BRIEF DESCRIPTION OF DRAWINGS

FIG. 1 is schematic representation of the major equipment employed in one application of this invention. The physical integration of the system components is depicted.

FIG. 2 is a temperature-entropy diagram which defines the thermodynamic conditions of the working fluid in a simple Rankine cycle with the heat inputs, heat rejection, work inputs and work outputs. The unique thermodynamic integration of nuclear generated heat is depicted.

### DESCRIPTION OF EMBODIMENTS

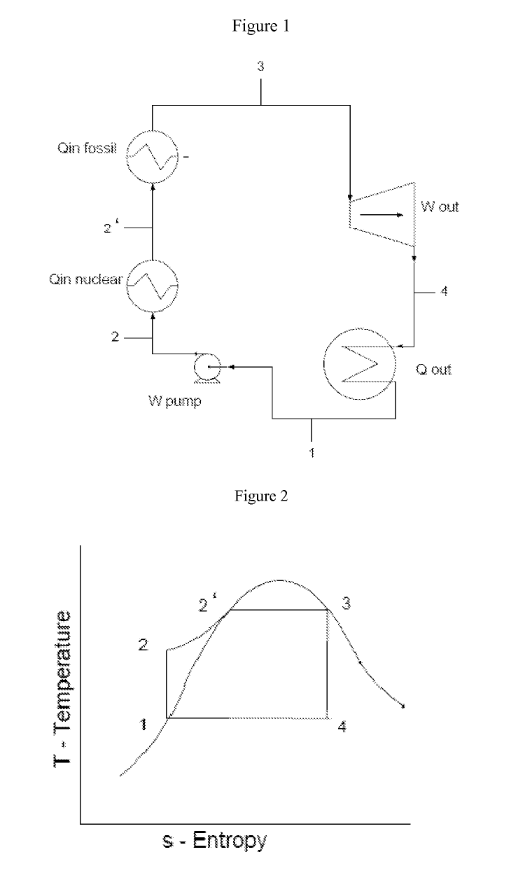

One embodiment of the invention presented herein is for application to an existing coal fired power plant employing the Rankine thermodynamic cycle. Referring to the drawings, and particularly the process diagram FIG. 1, this embodiment inserts the nuclear reactor as a heat input (Qin nuclear) to sub-cooled water 2 leaving the feed water pump (W pump). In this case sufficient heat is added to elevate the enthalpy of the water to that of a saturated liquid 2′. The saturated water is then input to the coal fired boiler which adds sufficient heat (Qin fossil) to raise the enthalpy of the water and water-steam mixture to that of a saturated vapor 3. The working fluid (steam) is subsequently directed the steam turbine (Wout) that extracts energy leaving the work fluid as a wet mixture 4. This mixture then enters the condenser (Qout) which reduces the enthalpy of the working fluid to that of a saturated liquid 1, and then directs the liquid back to the feed water pump (Wpump) in this sequence.

This same embodiment is reiterated in FIG. 2 which is a temperature—entropy diagram utilizing the same working fluid condition designations.

This specific case has been chosen because it represents a large population of prospective applications since at the time of this application approximately 56% of US electric generation is derived from coal. It is important to note that there are a large number of different specific arrangements of thermal power plant equipment, including differing implementations of the Rankine cycle based steam plant with one or more stages of superheat and reheat, combined (Brayton/Rankine) cycle gas turbine plants, and others for which this invention is also applicable. When applied to combined cycle plants the invention is applied as described above to the Rankine cycle portion of the plant.

Thus in accordance with the present invention there has been provided new and improved application of nuclear energy to the generation of electric power. This is accomplished by the unique and heretofore unrecognized invention of applying a nuclear reactor as a feedwater heater prior to the application of fossil based energy.

What is claimed is:

1. An electric generating system comprised of a nuclear reactor, fossil fueled boiler, heat exchangers, steam turbines, electric generator, pumps and interconnecting piping wherein the nuclear reactor heats feedwater prior to entering fossil fueled boiler and superheaters.

2. An electric generating system comprised of a nuclear reactor, combustion turbine, heat exchangers, steam turbines, electric generator, pumps and interconnecting piping wherein the nuclear reactor heats feedwater prior to entering boilers and superheaters.

3. A method for repowering existing electric generating plants utilizing the method described in either claim 1 or claim 2 that economically extends the useful life of the infrastructure equipment.
